(19) United States
(12) Patent Application Publication
(10) Pub. No.: US 2025/0323349 A1
(43) Pub. Date: Oct. 16, 2025

(54) STORAGE DEVICE AND METHOD FOR PRODUCING A STORAGE DEVICE

(71) Applicant: ElringKlinger AG, Dettingen (DE)

(72) Inventors: Lars WELLER, Kirchheim unter Teck (DE); Ulrich BENZEL, Dettingen (DE); Markus AICHELE, Lenningen (DE)

(73) Assignee: ElringKlinger AG, Dettingen (DE)

(21) Appl. No.: 19/250,858

(22) Filed: Jun. 26, 2025

Related U.S. Application Data
(63) Continuation of application No. PCT/EP2024/050115, filed on Jan. 3, 2024.

(30) Foreign Application Priority Data
Jan. 10, 2023 (DE) 10 2023 100 452.2

(51) Int. Cl. H01M 10/6568; H01M 10/0525; H01M 10/058; H01M 10/613; H01M 10/643; H01M 50/213; H01M 50/293

(52) U.S. Cl. CPC H01M 10/6568; H01M 10/0525; H01M 10/058; H01M 10/613; H01M 10/643; H01M 50/213; H01M 50/293

(57) ABSTRACT

A storage device for receiving, storing and releasing electrical energy, the storage device comprising the following: a plurality of storage cells; a connecting element that connects at least two of the storage cells; and a temperature control zone on one side of the connecting element; wherein the storage cells that are connected by the connecting element extend into the temperature control zone or through the temperature control zone; wherein the connecting element surrounds the cell casings of the storage cells that are connected by the connecting element and delimits the temperature control zone with respect to an adjacent zone; and wherein the connecting element may preferably form a barrier by way of which a passage of a temperature control fluid, which can be conducted in the temperature control zone, from the temperature control zone into the adjacent zone can be counteracted.

### RELATED APPLICATION

This application is a continuation of international application No. PCT/EP2024/050115 filed on Jan. 3, 2024, and claims the benefit of German application No. 10 2023 100 452.2 filed on Jan. 10, 2023, which are incorporated herein by reference in their entirety and for all purposes.

### FIELD OF DISCLOSURE

The present invention relates to the field of storage devices for receiving, storing and releasing electrical energy.

### BACKGROUND

As a result of growing electromobility, storage devices for receiving, storing and releasing electrical energy are acquiring ever greater importance, since they make available the energy needed for the propulsion of vehicles.

In principle, the receiving and releasing of electrical energy may be based upon electrochemical reactions or upon physical charge transfers.

If the receiving and releasing are based upon electrochemical reactions, a storage device may preferably be a battery device. If the receiving and releasing are based upon physical charge transfers, a storage device may preferably be a capacitor device.

Storage devices, in particular battery devices, can in particular comprise cylindrical storage cells, prismatic storage cells and/or pouch cells.

In particular, cylindrical or prismatic storage cells can be inserted directly during assembly into holding devices of a storage device which are provided for this purpose. The cells are retained mechanically or by material closure. Additional cooling systems are needed, which may include cooling pipes and/or cooling plates, for example.

A storage device constructed according to this principle can be produced only with relatively great effort. This is because the storage cells have to be inserted into the holding devices, and cooling pipes and/or cooling plates have to be integrated. The mechanical or materially closed linking of the storage cells may, in addition, hamper or prevent a necessary tolerance compensation of the storage cell in the device.

The object underlying the present invention is to make available a storage device that is capable of being produced with little effort and capable of being temperature-controlled efficiently, and a method for producing same.

### SUMMARY OF THE INVENTION

In accordance with the invention, this object is achieved by virtue of the storage device according to the independent claim relating thereto.

The storage device can be produced with little effort, in particular according to the method according to the invention also described herein.

The invention is based on the idea of enabling a temperature-control fluid to flow around storage cells with the least possible effort, in particular with the lowest possible number of components and/or sealing elements, while at the same time providing storage devices that require particularly little installation space.

The invention is also based on the consideration of minimizing the additional effort required to connect the storage device to a temperature-control fluid-carrying system of the vehicle and/or to mechanically connect it to load-bearing components of a vehicle.

Advantageously, the storage device can comprise the following:
a plurality of storage cells;
a connecting element that connects at least two of the storage cells; and a
temperature-control zone on one side of the connecting element;
wherein the storage cells connected by the connecting element extend into or through the temperature-control zone;
wherein the connecting element surrounds the cell casings of the storage cells connected by the connecting element and delimits the temperature-control zone from an adjacent zone,
wherein the connecting element can preferably form a barrier which can counteract the transfer of a temperature-control fluid, which can be guided in the temperature-control zone, from the temperature-control zone into the adjacent zone.

The number of the plurality of storage cells can preferably be 4 to 10,000, particularly preferably 8 to 4,800, most preferably 16 to 3,600.

The specification that at least two of the storage cells are connected by the connecting element can preferably mean that the number of storage cells connected by the connecting element can preferably be 4 to 10,000, particularly preferably 8 to 4,800, very particularly preferably 16 to 3,600.

The indication that at least two of the storage cells are connected by the connecting element can preferably mean that at least 25%, preferably at least 40% of the storage cells comprised by the storage device, particularly preferably at least 75% of the storage cells comprised by the storage device, are connected by the connecting element.

The at least two storage cells preferably each have a cell casing. The shape of the storage cells is not limited. Advantageously, the storage cells can be cylindrical or prismatic storage cells, e.g., cylindrical storage cells.

The cell casing can be a metal casing of the respective cell. Prismatic and cylindrical storage cells often have metal casings.

At least one of the storage cells can be a battery cell or a capacitor cell, preferably a battery cell. Preferably, the at least two storage cells connected by the connecting element can be battery cells and/or capacitor cells, preferably battery cells.

The term battery cell preferably refers to a rechargeable battery cell. The battery cell can be a rechargeable lithium-ion battery cell, for example.

The storage device for receiving, storing and releasing electrical energy may be an electrochemical storage device or a capacitive storage device or an electrochemical and capacitive storage device.

It may be advantageous if the storage device comprises a plurality of storage modules for receiving, storing and releasing electrical energy, wherein at least a first one of the storage modules may comprise a first portion of the plurality of storage cells, the connecting element connecting the at least two of the storage cells and the temperature-control zone on one side of the connecting element.

A further memory module can comprise a further portion of the plurality of storage cells.

The further memory module may comprise at least one further connecting element that connects at least two of the storage cells comprised by the further portion of the plurality of storage cells.

The further storage module can comprise a further temperature-control zone on one side of the further connecting element.

Storage cells connected by the further connecting element can extend into the further temperature-control zone or through the further temperature-control zone.

The further connecting element can surround the cell casings of the storage cells connected by the further connecting element and separate the further temperature-control zone from another adjacent zone.

The further connecting element can preferably form a further barrier, which can counteract the transfer of a temperature-control fluid, which can be guided in the further temperature-control zone, from the further temperature-control zone into the further adjacent zone.

The further adjacent zone can be a zone separate from the first adjacent zone or a zone that merges into the first zone or coincides with the first adjacent zone.

Preferably, the first storage module can be connected to a further storage module in an electrically conductive and/or temperature-controlled fluid-conducting manner.

The electrically conductive connection can be designed in such a way that electrically conductive energy can be absorbed, stored and/or released partly by the first and partly by the further storage module.

The temperature-control fluid-conducting connection can be designed in such a way that a temperature-control fluid can be guided successively through the first storage module and the further storage module, or it can be designed in such a way that a first partial flow of a temperature-control fluid flow can be guided through the first storage module and a further partial flow of the temperature-control fluid flow can be guided through the further storage module.

The storage device can be one for a fully or partially electrically powered vehicle. This can be a land vehicle (e.g., a road vehicle or a rail vehicle), an aircraft (e.g., an airplane) or a water vehicle (e.g., a ship). Preferably it is a road vehicle.

Advantageously, the connecting element can contain a plastics material and/or be formed partially or completely from a plastics material.

The connecting element may contain a plastics material. It can be partially formed from a plastics material. It can be formed entirely from a plastics material.

The connecting element may contain reinforcing elements. The reinforcing elements can be fibers, e.g., glass fibers or carbon fibers. Preferably, the reinforcing elements are embedded in the plastics material.

The plastics material can be a thermoset plastics material, an elastomeric plastics material or a thermoplastic plastics material.

The connecting element can be a thermoset connecting element, an elastomeric connecting element or a thermoplastic connecting element.

If the plastics material is a thermoset or an elastomeric plastics material, it is preferred if the plastics material is obtained or obtainable at a curing or vulcanization temperature which is at most 40 K, preferably at most 30 K, particularly preferably at most 20 K, e.g., at most 10 K, above a maximum temperature, at this maximum temperature or below this maximum temperature, wherein the maximum temperature is a temperature which the connected storage cells can withstand.

If the connecting element is a thermoset or an elastomeric connecting element, it is preferred if the connecting element is obtained or obtainable at a curing or vulcanization temperature which is at most 40 K, preferably at most 30 K, particularly preferably at most 20 K, e.g., at most 10 K, above a maximum temperature, at this maximum temperature or below this maximum temperature, wherein the maximum temperature is a temperature which the connected storage cells can withstand.

Preferably, the connecting element or the plastics material can be obtained or obtainable at a temperature of less than 100° C., preferably less than 90° C., particularly preferably less than 80° C., e.g., less than 70° C.

This is a particularly reliable way of preventing thermal damage to the storage cells.

Preferably, a contact area in which the connecting element is in contact with a cell casing can be at most 8 cm², preferably at most 6 cm², e.g., at most 4.5 cm².

Preferably, a contact area in which the connecting element is in contact with a cell casing can be at most 12%, preferably at most 9.5%, e.g., at most 6%, of an outer surface of the cell casing, wherein only the two end faces of the respective storage cell are not included in the calculation of the outer surface of the cell casing.

Such a small contact area can minimize the heat input into the interior of the storage cell during the production of the connecting element on the cell casing. In particular, heat transferred to a cell casing in the contact area can be distributed over the entire length of the storage cell in the cell casing and thus effectively released into the environment, so that the interior of the storage cell, e.g., an electrochemical storage core of the storage cell, is not thermally damaged.

One of the plurality of the cell casings can preferably be metal. This can promote heat transfer along the cell casings from the connecting element, which prevents excessive amounts of heat from being transferred into the interior of the storage cells.

If the plastics material is a thermoset plastics material or an elastomeric plastics material, the plastics material may preferably be a resin-based plastics material. The resin-based plastics material can preferably be a reactive resin-based plastics material.

The reactive resin-based plastics material can preferably contain at least one of the following reactive resins:
an unsaturated polyester resin (UP resin),
an epoxy resin (EP resins),
an isocyanate resin,
a methacrylate resin (MA resins),
a phenacrylate resin (PHA resins),
a spatially cross-linking polyurethane.

It can be particularly advantageous if the connecting element contains a potting compound and/or is partially or completely formed from a potting compound.

The connecting element can contain a potting compound. The connecting element can be partially or completely formed from a potting compound.

The potting compound can be a plastics potting compound.

The plastics potting compound may contain the plastics material and/or be partially or completely formed from the plastics material.

The potting compound, e.g., the plastics potting compound, can also contain the reinforcing elements. The reinforcing elements can be fibers, e.g., glass fibers or carbon fibers. Preferably, the fibers are embedded in the plastics material or dispersed in the potting compound.

It can be advantageous if the connecting element, preferably the plastics material or the potting compound, adheres to the cell casings of the storage cells connected by the connecting element.

It is advantageous if the connecting element, preferably the plastics material or the potting compound, is bonded to the cell casings of the storage cells connected by the connecting element.

It is preferred if the materially closed linkings of the connecting element, preferably the materially closed linkings of the plastics material or the materially closed linkings of the potting compound, are direct materially closed linkings with the cell casings. In particular, this can mean that the plastics material or the potting compound adheres directly to the cell casings of the storage cells connected by the connecting element, in particular without an additional connecting layer, e.g., without additional adhesive material and without an adhesive layer.

It is particularly advantageous if the barrier formed by the connecting element is in one piece and/or if the passage of the temperature-control fluid is counteracted without a sealing element, in particular without a sealing element between the cell casings connected by the connecting element and the connecting element.

In particular, but not only, the features described above can contribute to the fact that the storage device can be produced with particularly little effort and at the same time enables particularly efficient temperature control. In particular, the storage cells can be connected entirely without additional components, solely by means of a connecting element produced in situ, which connects the storage cells and can also form a wall of the storage device, which can mechanically stabilize the storage device and act as a barrier to prevent temperature-control fluid from escaping.

When reference is made herein to a temperature-control fluid, this refers in particular to a temperature-control liquid.

It is particularly advantageous if the connecting element is resistant to temperature-control liquids. Preferably, for example, the plastics material and/or the potting compound can be resistant to temperature-control liquids.

The resistance to temperature-control liquids can preferably exist in a temperature window that extends from −20° C. to +60° C.

Preferably, it can be tested as follows whether the connecting element, e.g., the plastics material and/or the potting compound, is resistant to temperature-control liquids:

The connecting element or a representative portion of the connecting element is removed from the storage device, cut into small pieces up to two millimeters thick, the pieces are weighed and the pieces are then stirred in a temperature-control liquid for three hours, wherein the ratio of the mass of temperature-control liquid to the mass of small pieces is 10:1. The pieces are then filtered off, washed with a further quantity of the same temperature-control liquid and the resulting filter cake is dried. The mass of the dried filter cake is determined and compared with the mass determined during the previous weighing of the pieces.

Temperature-control liquid resistance exists if the mass loss is at most 10%, e.g., at most 5%, of the mass determined during the previous weighing of the pieces.

Preferably, the connecting element is resistant to temperature-control liquid in the above-mentioned temperature window of −20° C. to 60° C. Whether the temperature-control liquid is resistant in this temperature window can be determined by carrying out the test at −20° C., 0° C., 20° C., 40° C. and 60° C., wherein the temperature of the temperature-control fluid is −20° C., 0° C., 20° C., 40° C. or 60° C. during stirring and washing. If the mass loss at each of the tested temperatures is at most 10%, e.g., at most 5%, the temperature-control liquid is resistant to a temperature-control liquid in the temperature window extending from −20° C. to 60° C.

This is advantageous, as low mass losses reduce the risk of leakage and thus ultimately efficient temperature-control can be achieved permanently, especially at frequently occurring extreme temperatures.

It can be advantageous if the connecting element is resistant to temperature-control liquid at a temperature of 60° C. This can be determined by carrying out the test at a temperature of 60° C., wherein the temperature of the temperature-control liquid is 60° C. during stirring and washing. This can often be sufficient to determine the resistance of the temperature-control liquid, as mass losses are generally higher at higher temperatures.

Preferably, the temperature-control liquid resistance of the connecting element can be to aqueous temperature-control liquids, to hydrocarbon-based temperature-control liquids and to perfluorinated temperature-control liquids.

Water can serve as a representative aqueous temperature liquid. If the temperature-control liquid resistance is also to be tested at temperatures of 0° C. or below, a mixture of 50% by weight ethylene glycol and 50% by weight water can be used as an aqueous temperature-control liquid.

A representative hydrocarbon-based temperature-control liquid is n-octane.

Perfluoro(2-methyl-3-pentanone) can serve as a representative perfluorinated temperature-control liquid. The representative temperature-control liquids mentioned are suitable for carrying out temperature-control liquid resistance tests, even if other temperature-control liquids may be preferred for temperature control of the storage device in a vehicle.

Insofar as a temperature-control liquid resistance is not specified in greater detail herein with regard to the temperature-control liquid, it is a temperature-control liquid resistance to a hydrocarbon-based temperature-control liquid, which can preferably be tested with n-octane.

It is particularly advantageous if the connecting element surrounds the cell casings of the storage cells connected by the connecting element and encloses them so tightly that the connecting element does not change its position on the cell casings over 100 pressure cycles when an overpressure of 3 bar is applied in the temperature-control zone.

This can be tested by increasing the pressure of a temperature-control liquid in the temperature-control zone, e.g., n-octane, of which the temperature is 20° C., 100 times from an initial pressure corresponding to the pressure in the adjacent zone to an overpressure of 3 bar compared to the pressure in the adjacent zone, maintaining the overpressure for one minute and then reducing it again to the pressure of the adjacent zone. The position of the connecting element on the cell casings is compared with the initial position of the connecting element on the cell casings.

It can be particularly advantageous if the connecting element is a first connecting element and the storage device comprises the following:
a second connecting element spaced from the first connecting element, which connects at least two of the storage cells, wherein the temperature-control zone extends between the first and second connecting elements.

It can be particularly advantageous if the storage device comprises at least one third connecting element extending from the first connecting element to the second connecting element, wherein the third connecting element can preferably form a barrier delimiting the temperature-control zone.

Preferably, the first connecting element can merge into the second connecting element via the third connecting element.

It can be particularly advantageous if the storage device comprises at least one fourth connecting element extending from the first connecting element to the second connecting element, wherein the fourth connecting element can preferably form a barrier delimiting the temperature-control zone.

Preferably, the first connecting element can also merge into the second connecting element via the fourth connecting element, wherein the fourth connecting element and the third connecting element can form opposing barriers that delimit the temperature-control zone.

It can be particularly advantageous if the storage device comprises
at least one insert for mechanically connecting the storage device to the vehicle, e.g., to a load-bearing component of the vehicle, and/or
at least one fluid connection element for connecting the storage device to a temperature-control fluid-carrying system of the vehicle.

The at least one insert and/or the at least one fluid connection element is preferably integrated into one of the connecting elements, e.g., molded therein or incorporated therein by at least partial hardening of a plastics material contained in the connecting element.

Preferably, the insert and/or the fluid connection element has an incorporation element, e.g., an undercut element. The incorporation element can protrude from a surface of the insert and/or the fluid connection element embedded in the connecting element or can be a recess extending into the embedded surface of the insert. Preferably, the insert and/or the fluid connection element can thereby be anchored in the respective connecting element.

The at least one insert can have a recess. The insert can function as an attachment element. In particular, the insert can be a threaded element. A thread, e.g., an internal thread, can be formed in a recess of the insert. A thread of a screw or bolt, which can be used to attach the storage device to a motor vehicle, can engage in the thread.

According to the invention, the object is achieved by the method according to the independent claim relating thereto.

The method is a method for producing a storage device for receiving, storing and releasing electrical energy.

In particular, it may be a method for producing a storage device according to the invention described herein.

The method is a method wherein at least two storage cells are arranged by means of an auxiliary element. For example, the at least two storage cells can be brought into a storage cell target arrangement by means of the auxiliary element.

The method is a method wherein a connecting element is formed on the cell casings of the at least two arranged storage cells such that the connecting element surrounds the cell casings of the storage cells. For example, a connecting element can be formed on the cell casings of the at least two storage cells placed in the storage cell target arrangement such that the connecting element surrounds the cell casings of the storage cells.

The auxiliary element can contain a plastic or be formed from a plastic. Preferably, the auxiliary element can contain a plastics foam or be formed from a plastics foam. The auxiliary element can preferably be an auxiliary element that is soluble in a solvent.

This is particularly advantageous if the method is carried out in such a way that the auxiliary element is positioned between connecting elements in such a way that it can no longer be removed mechanically between the connecting elements.

Preferably, the auxiliary element has at least two receiving zones for receiving the at least two storage cells. By accommodating the at least two storage cells in the at least two receiving zones of the auxiliary element, the at least two storage cells can, for example, be brought into the storage cell target arrangement.

Preferably, the connecting element on the cell casings of the at least two storage cells can be formed from a flowable precursor compound. The flowable precursor compound can contain a flowable plastics material or a flowable precursor material of a plastics material and/or be formed partially or completely from the flowable plastics material or from the flowable precursor material of the plastics material.

It is particularly advantageous if the connecting element is formed on connecting portions of the cell casings that protrude beyond a surface of the auxiliary element.

Connecting portions of the cell casings are preferably portions of the cell casings that differ from adjacent portions of the cell casings only in that they are arranged differently in relation to the auxiliary element. In particular, cell casings are typically not different in connecting portions than in adjacent portions of the cell casings. The connecting portions preferably merge seamlessly into the adjacent portions of the cell casings.

It is particularly advantageous if the connecting element is formed from a flowable precursor compound at the connecting portions of the cell casings, wherein the precursor compound is applied to the surface in such a way that the precursor compound surrounds the cell casings at the connecting portions and comes into contact with the cell casings there.

It may be preferred if the flowable precursor compound is a potting compound or contains a plastics material or a precursor of a plastics material. In particular, the precursor compound may contain reactive precursors of a resin, e.g., a reactive resin mentioned herein.

The flowable precursor compound may contain the reinforcing elements described herein. Preferably, the reinforcing elements are dispersed in the flowable precursor compound.

It can be advantageous if the connecting element is formed on first connecting portions of the cell casings that protrude beyond a first surface of the auxiliary element. This connecting element can be a first connecting element. A second connecting element can be formed at second connecting portions of the cell casings that protrude beyond a second surface of the auxiliary element. The second surface of the auxiliary element can be a surface arranged opposite the first surface of the auxiliary element. The first and second surfaces of the auxiliary element can be opposite surfaces of the auxiliary element facing away from each other.

It may be preferable if the first connecting element is formed from a flowable precursor compound at the first connecting portions of the cell casings, wherein the precursor compound is applied to the first surface in such a way that the precursor compound surrounds the cell casings at the first connecting portions and comes into contact with the cell casings there, and the second connecting element is formed from a flowable precursor compound at the second connecting portions of the cell casings, wherein the precursor compound is applied to the second surface in such a way that the precursor compound surrounds the cell casings at the second connecting portions and comes into contact with the cell casings there. It is preferable to turn the auxiliary element and the at least two storage cells arranged by means of the auxiliary element, as well as the first connecting element formed on the first surface, before the precursor compound is applied to the second surface.

It can be particularly advantageous if, in the method, at least one insert and/or at least one fluid connection element is arranged before or during the application of the precursor compound to a surface of the auxiliary element in such a way that the precursor compound surrounds the at least one insert and/or the at least one fluid connection element.

The at least one insert can have a recess. The insert can form an attachment element via which the storage device can be arranged in a motor vehicle. The attachment element can be a threaded element. A thread, e.g., an internal thread, can be formed in the recess.

The at least one fluid connection element can preferably be positioned and aligned in such a way that the precursor compound surrounding the fluid connection element results in a barrier through which the fluid connection element passes.

It can be advantageous to position the at least one fluid connection element on an end face of the auxiliary element and to apply a precursor compound to the end-face surface in such a way that the precursor compound surrounds the fluid connection element on the end-face surface.

It may be preferable if the at least one insert is positioned and aligned on the first or second surface such that the precursor compound surrounding the cell casings at the first or second connecting portions also surrounds the at least one insert.

It can be particularly advantageous if the auxiliary element is detached from the connecting element or from the first and second connecting elements. The auxiliary element can preferably be detached using a solvent with which the auxiliary element is completely or partially dissolved. It may be preferable to feed the solvent to the auxiliary element through the at least one fluid connection element.

The object is also achieved by a storage device obtainable or produced according to the method according to the invention for receiving, storing and releasing electrical energy, wherein the storage device is preferably a storage device according to the invention as described herein.

Of course, features described in conjunction with a subject matter according to the invention can also form features of another subject matter according to the invention described herein. In particular, subjects according to the invention are the storage device and the method for producing a storage device.

Preferably, at least two, particularly preferably at least three, e.g., at least four of the connecting elements described herein or all of the connecting elements of a storage device described herein may contain the same plastics material and/or be formed partially or completely from the same potting compound.

Further preferred features and/or advantages of the invention are the subject of the following description and the illustration of exemplary embodiments.

### BRIEF DESCRIPTION OF THE DRAWINGS

FIG. 1: a schematic representation of a plurality of storage cells arranged by means of an auxiliary element;

FIG. 2: the application of flowable precursor compound on a surface of the auxiliary element shown in FIG. 1;

FIG. 3: an arrangement comprising an auxiliary element, a first connecting element and a plurality of storage cells;

FIG. 4: the application of a flowable precursor compound to a remaining surface of the auxiliary element in the arrangement shown in FIG. 3;

FIG. 5: the arrangement as shown in FIG. 4 with an additional second connecting element;

FIG. 6: the arrangement from FIG. 5 with additional cell contacting system;

FIG. 7: the application of further flowable precursor compound around a fluid connection element;

FIG. 8: the arrangement from FIG. 6 with additional fluid connection elements integrated on the end face;

FIG. 9: a storage device obtained according to the method shown in FIGS. 1 to 8;

FIG. 10: a schematic representation of a storage device without a cell contacting system; and

FIG. 11: the storage device according to FIG. 10 with cell contacting system.

Like or functionally equivalent elements are provided with the same reference signs in all figures.

### DETAILED DESCRIPTION OF THE DRAWINGS

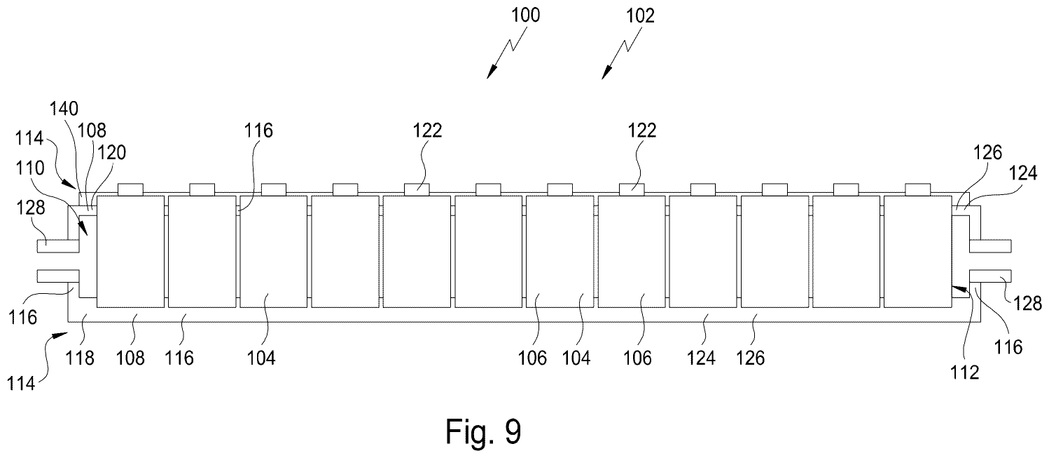

FIG. 9 shows a storage device 100 for receiving, storing and releasing electrical energy. The storage device 100 is a battery device 102.

The storage device 100 comprises a plurality of storage cells 104. The storage cells 104 are battery cells 106, for example lithium-ion battery cells, in particular cylindrical lithium-ion battery cells.

The storage device 100 comprises a connecting element 108 that connects the storage cells 104.

The storage device 100 additionally comprises a temperature-control zone 110 on one side of the connecting element 108.

The storage cells 104 connected by the connecting element 108 extend through the temperature-control zone 110. The storage cells 104 each have a cell casing 112. The connecting element 108 surrounds the cell casings 112 of the storage cells 104 connected by the connecting element 108. The connecting element 108 delimits the temperature-control zone 110 from an adjacent zone 114, which in the present example is located outside the storage device 100.

The connecting element 108 forms a barrier 116. The barrier 116 counteracts the transfer of a temperature-control fluid, which can be guided in the temperature-control zone 110, from the temperature-control zone 110 into the adjacent zone 114. The zone 114 described up to this point is shown in FIG. 9 below the connecting element 108, which is formed on the underside of the storage device 100.

The connecting element 108 described up to that point with reference to FIG. 9 is a first connecting element 118. In addition, the storage device 100 shown in FIG. 9 comprises a second connecting element 120 spaced apart from the first connecting element 118. The second connecting element 120 also connects the storage cells 104. The temperature-control zone 110 extends between the first connecting element 118 and the second connecting element 120.

The storage cells 104 have contacts 122. The storage device 100 can be connected to a cell contacting system 140 via the contacts 122.

The first connecting element 118 and the second connecting element 120 are each formed from a potting compound 124. The potting compound 124 contains a plastics material 126, for example a reactive resin.

On the two end faces shown on the left and right in FIG. 9, the temperature-control zone 110 is delimited in each case by a barrier 116 also formed from the potting compound 124. Fluid connection elements 128 are arranged in these two barriers 116.

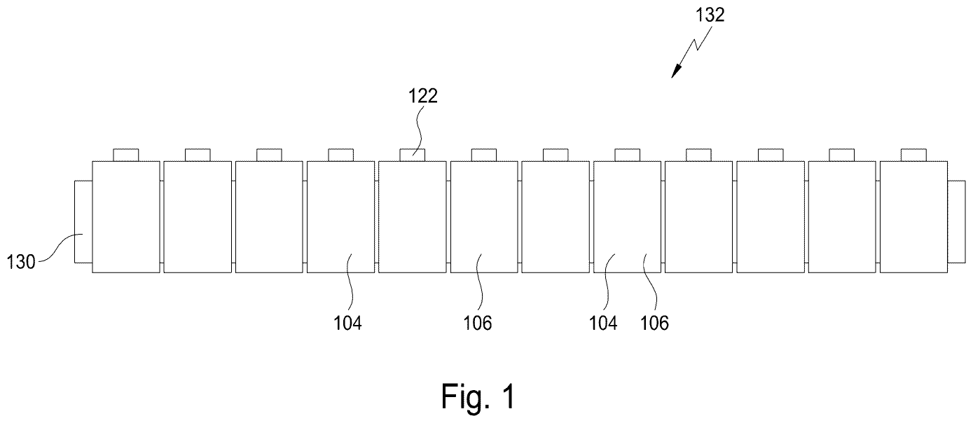

FIGS. 1 to 8 illustrate the production of the storage device 100, shown in FIG. 9, according to a method according to the invention.

FIG. 1 shows the storage cells 104. The storage cells 104 are arranged by means of an auxiliary element 130. The storage cells 104 have been brought into the storage cell target arrangement 132 shown in FIG. 1 by means of the auxiliary element 130. The auxiliary element 130 may, for example, be formed from a soluble plastics foam, such as polystyrene.

The storage cells 104 can be arranged in cylindrical cut-outs of the auxiliary element 130, which are not shown in FIG. 1.

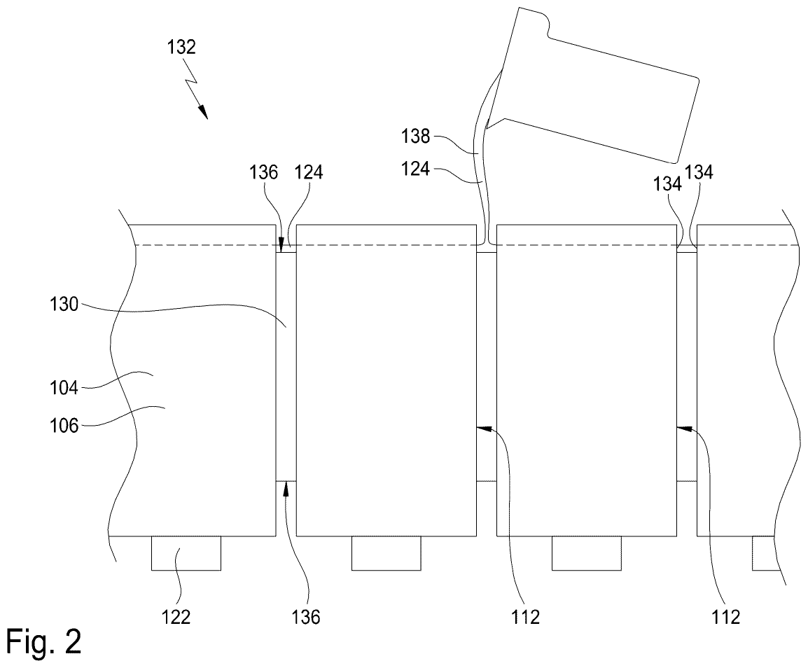

FIG. 2 shows a detail from FIG. 1, in which the storage cell target arrangement 132 is shown reversed. FIG. 2 illustrates how a connecting element 108 is formed on the cell casings 112 of the storage cells 104 such that the connecting element 108 surrounds the cell casings 112 of the storage cells 104.

The connecting element 108 is formed at connecting portions 134 of the cell casings 112, wherein the connecting portions 134 protrude beyond a surface 136 of the auxiliary element 130.

The connecting element 108 is formed at the connecting portions 134 of the cell casings 112 from a flowable precursor compound 138. The precursor compound 138 is applied to the surface 136 in such a way that the precursor compound 138 surrounds the cell casings 112 at the connecting portions 134 and comes into contact with the cell casings 112 there.

The flowable precursor compound 138 is a potting compound 124.

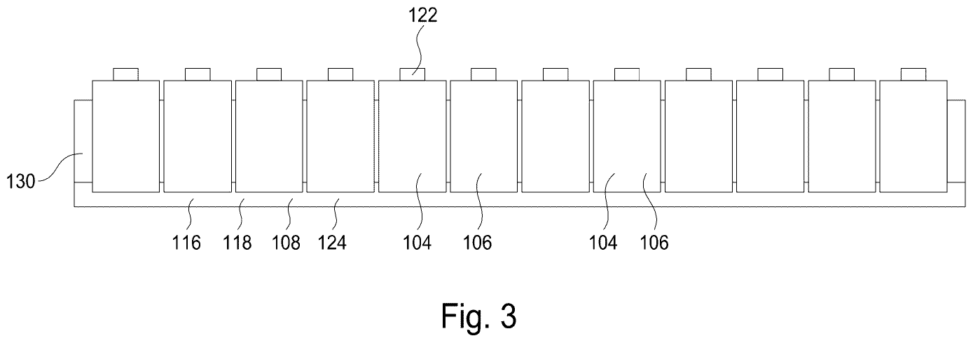

FIG. 3 shows the state that occurs after complete application of the precursor compound 138. The ends of the storage cells 104 facing away from the contacts 122 are completely covered by the connecting element 108, i.e., the first connecting element 118.

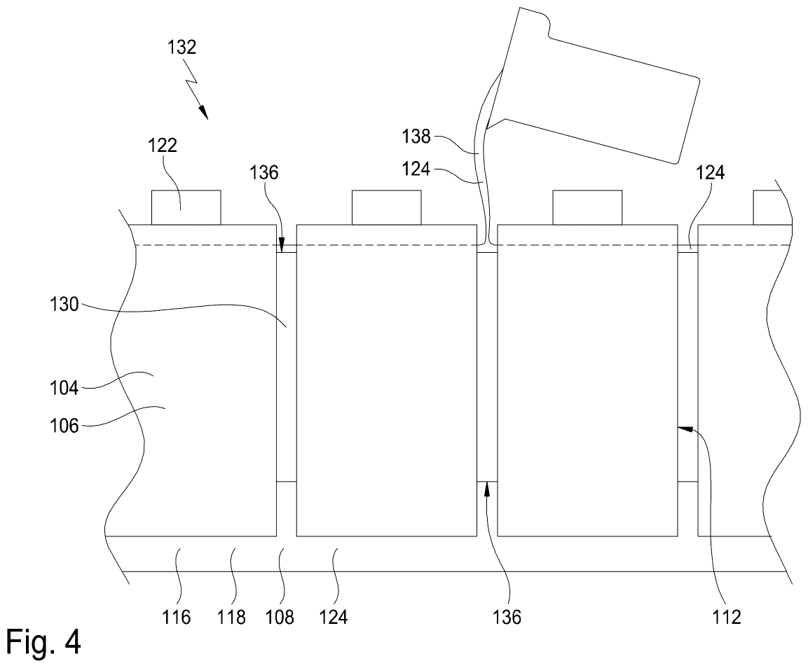

FIG. 4 illustrates the production of the second connecting element 120 on the cell casings 112 of the storage cells 104. The second connecting element 120 is also formed in such a way that the connecting element 120 surrounds the cell casings 112 of the storage cells 104.

The second connecting element 120 is also formed at connecting portions of the cell casings 112. These connecting portions protrude beyond a further surface 136 of the auxiliary element 130.

FIG. 4 shows that this surface 136, on which the second connecting element 120 is formed, is arranged on the other side of the auxiliary element 130 than the surface 136 on which the first connecting element 118 was formed.

The second connecting element 120 is also formed at the cell casings 112 from a flowable precursor compound 138. The precursor compound 138 is a potting compound 124. The precursor compound 138 is applied to the surface 136 in such a way that the precursor compound 138 surrounds the cell casings 112 at the connecting portions and also comes into contact with the cell casings 112 there.

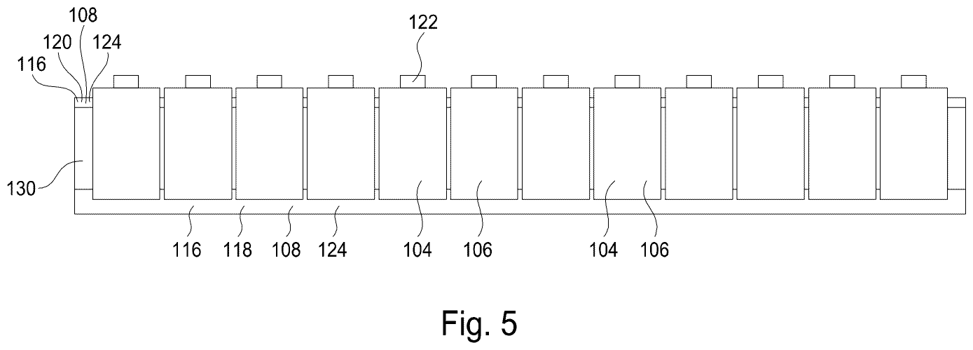

FIG. 5 shows the state obtained after carrying out the production step shown in FIG. 4.

The auxiliary element 130 extends between the first connecting element 118 and the second connecting element 120.

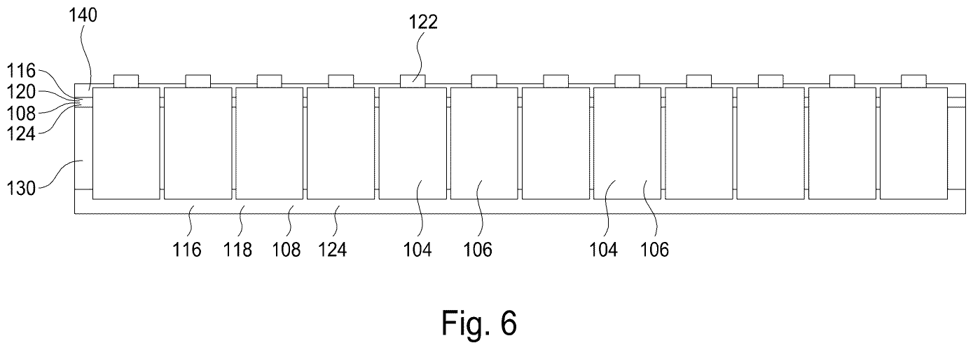

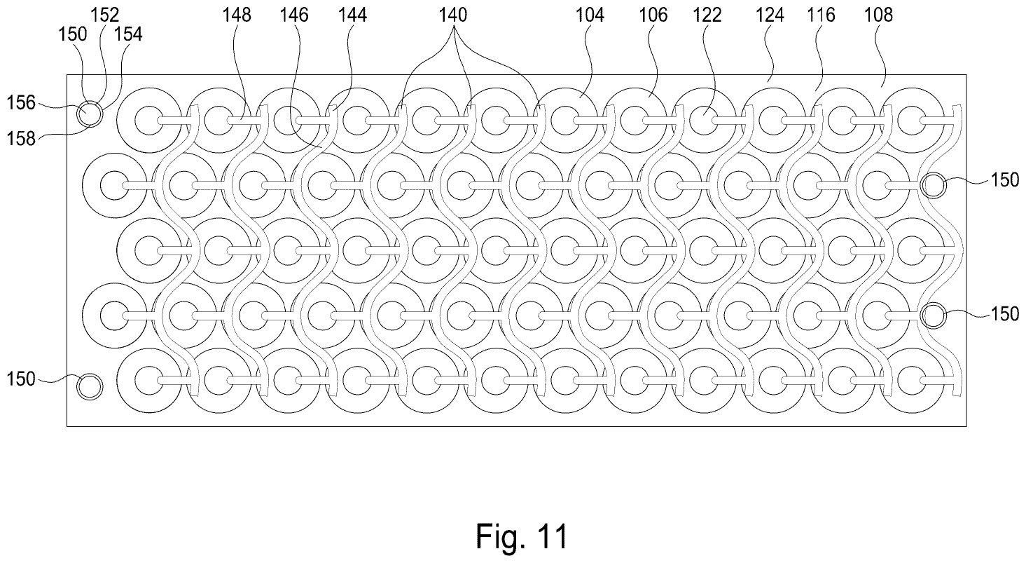

FIG. 6 shows the state of FIG. 5, wherein a cell contacting system 140 is additionally arranged at the contacts 122. FIG. 6 shows the cell contacting system 140 schematically. Details of a cell contacting system 140 can be taken from FIG. 11, which is described further below.

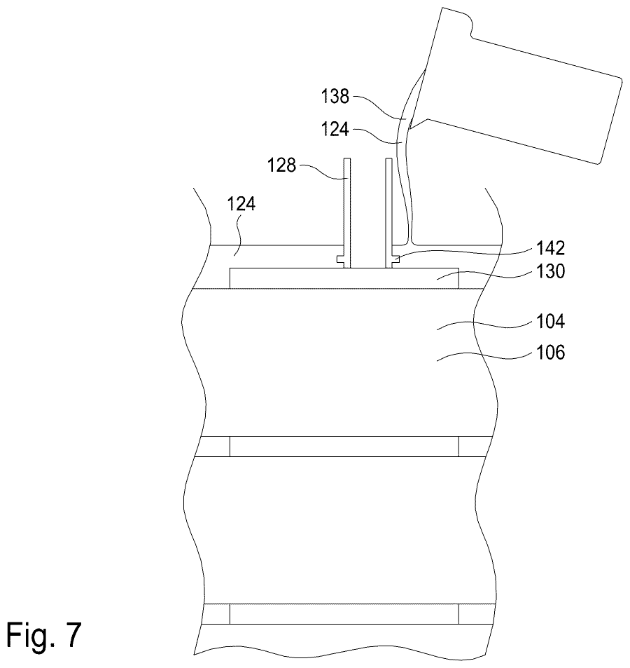

FIG. 7 shows a detail from FIG. 5 and FIG. 6, rotated by 90 degrees. A storage cell 104 shown on the far left in FIGS. 5 and 6 is shown at the top in FIG. 7. FIG. 7 illustrates how a fluid connection element 128 is positioned on an end-face surface of the auxiliary element 130 and is cast in with a precursor compound 138, which may be a potting compound 124, for example. In the example shown there, the fluid connection element 128 has undercut elements 142. These are covered by the precursor compound 138, so that the fluid connection element is firmly anchored as soon as the precursor compound 138 has solidified or hardened.

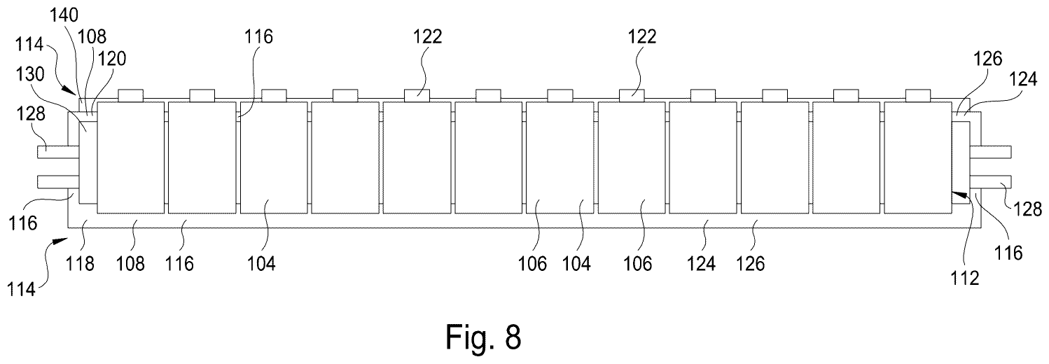

FIG. 8 corresponds to FIG. 9, wherein the space occupied by the temperature-control zone 110 in the storage device 100 from FIG. 9 is still occupied by the auxiliary element 130.

The auxiliary element 130 can consist of a deliverable plastics material, e.g., of a polymer foam that is soluble in a solvent or of a pyrolyzable polymer foam. In the example shown here, the auxiliary element 130 consists of a soluble plastics foam, for example polystyrene. For example, a solvent can be supplied via one of the fluid connection elements 128. The solvent can dissolve the auxiliary element 130 and the dissolved auxiliary element 130 can be sucked out of the further fluid connection element 128 with the solvent.

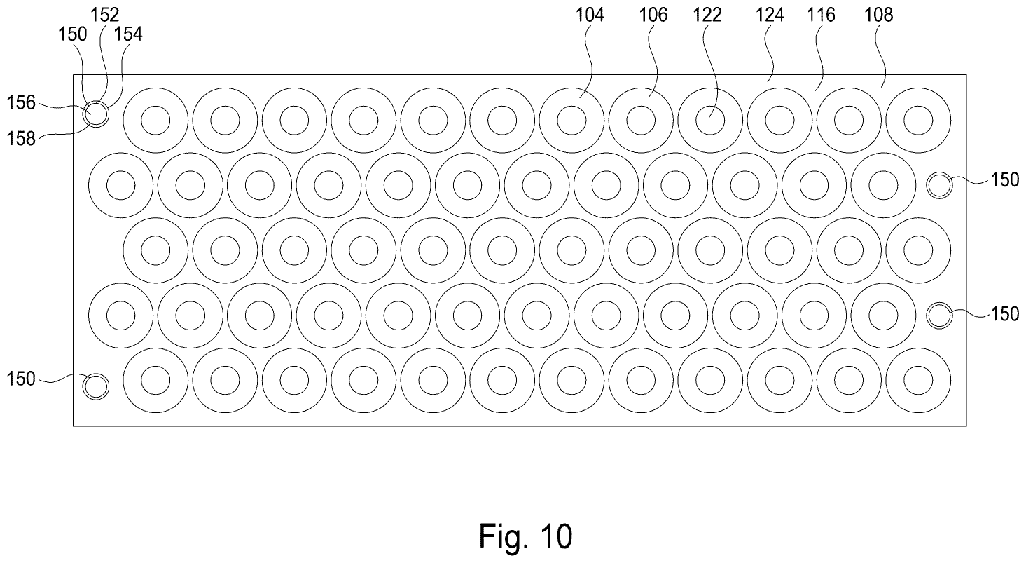

FIG. 10 shows the storage device 100 from FIG. 9 from above, with a view of the contacts 122. The cell contacting system 140 has been omitted in FIG. 10. FIG. 10 shows that inserts 150 are integrated into the connecting element 108 acting as a barrier 116.

For example, the inserts 150 may be integrated in the formation of the connecting element 108 as described with respect to FIG. 7 and to the fluid connection element 128 shown therein.

An insert shown in FIG. 10 can be used in particular for the mechanical connection of the storage device 100 in a motor vehicle. The insert 150 can have a recess 152. It can function as an attachment element 154. In particular, the insert 150 can be a threaded element 156. A thread 158, e.g., an internal thread, can be formed in the recess 152. A thread of a screw or bolt, which can serve to fasten the storage device 100 to a motor vehicle, can engage in the thread 158.

FIG. 11 shows the view from FIG. 10, wherein a cell contacting system 140 is additionally arranged on the contacts 122. The cell contacting system 140 comprises cell connectors 144, electrical conductors 146 and bonding wires 148. The electrical conductors 146 run inside the cell connectors 144. They are connected to the contacts 122 of the storage cells 104 via bonding wires 148.

### LIST OF REFERENCE SIGNS

100 storage device
102 battery device
104 storage cell
106 battery cell
108 connecting element
110 temperature-control zone
112 cell casing
114 zone
116 barrier
118 first connecting element
120 second connecting element
122 contact
124 potting compound
126 plastics material
128 fluid connection element
130 auxiliary element
132 storage cell target arrangement
134 connecting portion
136 surface
138 precursor compound
140 cell contacting system
142 undercut element
144 cell connector
146 electrical conductor
148 bonding wire
150 insert
152 recess
154 attachment element
156 threaded element
158 thread

1. A storage device for receiving, storing and releasing electrical energy, the storage device comprising:
a plurality of storage cells;
a connecting element connecting at least two of the storage cells; and
a temperature-control zone on one side of the connecting element;
wherein the storage cells connected by the connecting element extend into the temperature-control zone or through the temperature-control zone;
wherein the connecting element surrounds the cell casings of the storage cells connected by the connecting element and delimits the temperature-control zone from an adjacent zone.

2. The storage device as claimed in claim 1, wherein
the connecting element forms a barrier which can counteract the transfer of a temperature-control fluid, which is guided in the temperature-control zone, from the temperature-control zone into the adjacent zone.

3. The storage device as claimed in claim 1, wherein
the connecting element contains a plastics material and/or is partially or completely formed from a plastics material.

4. The storage device as claimed in claim 1, wherein
the connecting element contains a potting compound and/or is formed partially or completely from a potting compound.

5. The storage device as claimed in claim 2,
wherein the connecting element or the plastics material or the potting compound adheres to the cell casings of the storage cells connected by the connecting element,
wherein the connecting element or the plastics material or the potting compound is linked by material closure to the cell casings of the storage cells connected by the connecting element,
wherein the materially closed linkings of the connecting element or the materially closed linkings of the plastics material or the materially closed linkings of the potting compound with the cell casings are direct materially closed linkings, and/or wherein the barrier formed by the connecting element is in one piece and/or the passage of the temperature-control fluid is counteracted without a sealing element, or without a sealing element between the cell casings connected by the connecting element and the connecting element.

6. The storage device as claimed in claim 1,
wherein the connecting element is resistant to temperature-control liquids, and/or
wherein the plastics material and/or the potting compound can be resistant to temperature-control liquids.

7. The storage device as claimed in claim 1,
wherein the connecting element is a first connecting element and the storage device comprises the following:
a second connecting element spaced from the first connecting element and connecting at least two of the storage cells, and wherein the temperature-control zone extends between the first and second connecting elements.

8. A method for producing the storage device as claimed in claim 1, wherein
at least two storage cells are arranged by means of an auxiliary element or brought into a storage cell target arrangement, and
a connecting element is formed on the cell casings of the at least two arranged storage cells or brought into the storage cell target arrangement, such that the connecting element surrounds the cell casings of the storage cells.

9. The method as claimed in claim 8, wherein
the connecting element is formed at connecting portions of the cell casings which protrude beyond a surface of the auxiliary element.

10. The method as claimed in claim 8,
wherein the connecting element is formed at the connecting portions of the cell casings from a flowable precursor compound, wherein the precursor compound is applied to the surface in such a way that the precursor compound surrounds the cell casings at the connecting portions and comes into contact with the cell casings there, and/or
wherein the flowable precursor compound is a potting compound or contains a plastics material or a precursor of a plastics material.
